(19) United States
(12) Patent Application Publication
(10) Pub. No.: US 2018/0048059 A1
(43) Pub. Date: Feb. 15, 2018

(54) Tension Structure For The Spatial Positioning Of Functional Elements

(71) Applicant: Tentguild Eng. Co., Boulder, CO (US)

(72) Inventor: Gyula Istvan Greschik, Boulder, CO (US)

(73) Assignee: Tentguild Eng. Co., Boulder, CO (US)

(21) Appl. No.: 15/556,050

(22) PCT Filed: Mar. 8, 2016
(86) PCT No.: PCT/HU2016/000013

§ 371 Date: Sep. 6, 2017

(30) Foreign Application Priority Data
Mar. 9, 2015 (HU) P1500095
Dec. 31, 2015 (HU) P1500654

(51) Int. Cl. H01Q 1/28; H01Q 1/08; H01Q 3/01

(52) U.S. Cl. CPC H01Q 1/28; H01Q 3/01; H01Q 1/08; B64G 1/22

(57) ABSTRACT

The invention is a structure, comprising
a first functional element (11) and a second functional element (12), said functional elements (11, 12) being form-retentive and being cooperatively functional in an operational state of the structure, in said operational state the functional elements (11, 12) having a predetermined relative spatial arrangement and being distanced from each other;
a tension assembly (20) coupling the functional elements (11, 12) to each other, the tension assembly (20) being adapted to be taut in said operational state and being coupled to the first functional element (11) by respective first couplings and to the second functional element (12) by respective second couplings; the functional elements (11, 12), the couplings and the tension assembly (20) together forming a tensioned assembly; and
a tensioning assembly (30) coupled to the tensioned assembly, the tensioning assembly (30) being adapted to exert a repulsive force distancing the first functional element (11) and the second functional element (12) for maintaining said operational state,
   wherein the system compliance of the tensioned assembly is less than 60% of the system compliance of the tensioning assembly (30).

### TECHNICAL FIELD

The invention relates to a structure that offers the possibility to create construction systems for various purposes, especially for devices for the manipulation of electromagnetic waves. Relative spatial positioning of separate device elements or device subsystems of self-maintained shapes is achieved via tension components or tension subsystems between, and tension in the connecting tension elements or subsystems is maintained by substantially less stiff structures or structural elements.

### BACKGROUND ART

Instruments and devices that interact with (sense, emit, filter, transform, receive, reflect, refract, actively process, interpret information embedded in, provide protection from, etc.) electromagnetic (EM) radiation energy and energy patterns are essential to modern technology. In space, such devices are the core equipment elements for a number of missions. Astronomical research, communication, remote sensing, and surveillance are just a few examples.

Generally, for such devices, the geometric precision of individual device elements (such as the surface shape of a telescope mirror) and the relative positioning of device elements (e.g., the positioning of the feed of a reflector antenna with respect to the antenna dish) are essential requirements. Geometric precisions can be one to two orders of magnitude more stringent than the wavelength of the concerned EM radiation. This becomes an increasingly difficult technological challenge as higher and higher EM frequencies (with associated lower and lower wavelengths) are considered with the advancement of the state of the art. Radar radiation (wavelengths down to 1 mm) can already be difficult to manage in some cases. The sufficiently precise management of visible light (wavelengths down to 1 micron) already imposes practically insurmountable challenges in many cases. For X-ray (down to nanometer-class wavelengths) even providing proper and efficient reflective surfaces can be a problem in space, where structural and equipment weight are also a prohibitively critical concern.

The severity of these geometric challenges are greatly aggravated by equipment dimensions and dimensional trends. For all wavelength, industrial, scientific, and military demand increases for ever greater dimensions.

Although aggressive innovations in electronics and signal processing technology (e.g., synthetic aperture radar, phased array antenna technology, very large baseline technology for interferometry) have reduced some dimensional needs for certain devices, device size even for those application can still be large. Hundred-meter class radar devices, several-meter class optical devices are being currently pursued. Larger dimensions make the device and its components much more difficult to fabricate.

Furthermore, the larger a structure, the more sensitive it generally is to effects of the space environment (extreme thermal effects, and dynamic disturbances by pointing and orbit adjustments) and render the challenge of packaging more difficult (the device has to autonomously open up to its operating dimensions from a state compact enough to fit the shroud of the launch vehicle, e.g., the tip of a rocket).

Despite the enormous variety of deployable technologies already developed (self-deployment by elastic means, deployment by hinged-actuated mechanics, by pressurization, by centrifugal force, by gravity gradient effects, etc.) the deployment problem for most precision devices managing EM radiation patterns is far from being sufficiently solved, especially for low wavelengths (high frequencies). For low wavelengths, the sheer structural deformations as a result of environmental effects (thermal changes, disturbances) and geometric repeatability (precision) issues of various deployable components (such as hinges, inflatable elements) by themselves can easily be greater than the precision required of the device, handicapping overall precision.

The quest to improve deployment technology and its elements for precision applications is ongoing. A good example is optical telescopy in space, which requires solid mirror surfaces (unlike stretchable mesh dishes for RF or radar applications) and/or sensitive flat diffractive sheet elements (e.g., membranes for “photon sieves”). Such elements have to be very precisely positioned and aligned but their size may require that they be divided into segments, for stowage. The segments then have to be moved (opened up) into their final locations with extreme precision. Hinges, springs, flexures, struts, auxiliary trusses, and an array of other elements are generally used to aid this goal. Such mechanical elements, although enabling the deployment process, also limit stowage options and overall precision. For example, a hinge between two device elements (e.g., two mirror segments) allows the device to be articulated (“folded”), but it also severely constrains how the joined components can be placed in stowage because they both are locked to the hinge. Further, the hinge itself can introduce geometric imprecision into the deployed device. Thus, although much progress in hinge, flexure, articulation, truss, and actuation technology has been made, technology still has very severe—in fact, prohibitive—limitations.

However, despite aggressive research worldwide, certain design paradigms have not yet been questioned. For example, for the herein concerned applications where relatively stiff or entirely solid device elements need to be positioned with a given spatial geometry, those elements are always integrated into a structural system (that ultimately constitutes the device) with fixed (solid-flexed-articulated) structural solutions playing the key structural role. If so-called tension elements (like cables or cords which are unfit to bear compression or flexure but can efficiently bear tension when stretched) appear, they do so to complement solid elements.

In such applications, the reflective components often include solid rigid surfaces, the refractive components often include lenses, and the diffractive components are often rigid frames with one or more pieces of stretched membrane within. The solid-articulated structures integrating these individual devices consist of trusses, hinged frames, masts, tubes, etc. Consequently, the design of a stowage and of deployment kinematics becomes difficult to engineer, and the precision of the deployment device ends up partly or fully depending on the precision of the used rigid (compression) elements and on the flexed or hinged stowage articulation mechanisms.

Much research continues to focus on improving such solutions, within the general constrains imposed by the philosophy of rigid-flexed-hinged mechanisms. This philosophy results in structures the deployment of which can be closely controlled, but the design itself of stowage itself remains very severely constrained. The paradigm of relying on solid, folded-stowed support structural elements when supporting relatively stiff or entirely solid device elements hasn't been abandoned. The prevailing engineering thinking deeply associates functional elements of stable shapes with classic mechanical deployment and structural solutions. This is so despite the fact that tension elements and tension structures are often easier to engineer for precision and stiffness, and are dramatically easier to stow, than rigid-flexed-articulated system.

Tension elements and tension structures are generally known; they have been amply represented throughout the history of technology. Most examples from the past are deployable structures (sails, nets, tents, etc.), but non-deployable applications also exist (bridge suspension systems, etc.). Due to their structural efficiency, ease of packaging, and relatively easy engineering for precision, such elements are abundant in space technology as stiffener cables, networks that maintain the shape of pliable medium-precision surfaces, tendons to enforce the precision of deployable mechanisms, preloaded and preloading members, etc. In some of these applications, some of the functional components of the device are tension structures themselves, stretched and preloaded by cables, etc., to form a coherent tension system. Components (springs, etc.) that exert in a compliant manner a preloading force onto other parts of the system are also common.

Further, in some tension systems, non-tension (solid) support elements that are fit to resist compression and flexure appear “purely” suspended with tension elements without solid links to other non-tension parts of the system. Such solutions either involve suspension from a rigid non-tension support (frame, boom, tube, truss), or are “tensegrity structures” within which rod-like support elements are integrated with cables.

Tensegrity structure are a special class wherein solid (compression- and flexure-bearing) elements are not connected to one another directly, only indirectly, via tension elements. In these structures, the solid elements (typically, struts) appear suspended in a network of tension elements (typically, cables, cords, etc.). Tensegrity technology is well known, and has been used and proposed multiple times both for Earth-based and space-based applications, e.g. in U.S. Pat. No. 3,063,521. A characteristic aspect of all of these applications is that the involved rigid elements are structural: their shape, location, and sizing is defined to serve the sole purpose to bear loads in an efficient manner and help the entire structure to do so. This characteristic is deeply embedded in engineering thinking. No tensegrity structure has even been proposed before in which the rigid elements are not structural.

In the context of space, tensegrity structures typically take the form of tensegrity columns or rings in which tension and tension-compression elements (e.g., cables and rods) together form the column or the ring, to support some instrument at the end or to hold the rim of a flexible reflector surface (e.g., the dish surface of a mesh antenna) within.

Within the context of functional device elements of stable shapes, the use of stiff and precise tension (cord, film, or fabric-like) elements is typically limited to complementing rigid structures that govern the construction, or to simply locking solid elements to each other. One such example is a bicycle wheel-like telescope where cable spokes suspend a mirror ring from a central column (J. J. Rey, et. al.: A deployable, annular, 30 m telescope, space-based observatory. Proc. SPIE, Volume 9143, id. 914318 pp. 14, 2014. DOI: 10.1117/12.2057182, Bibliogr. Code: 2014SPIE.9143E . . . 18R). In this case, the mirror ring is supported solely by tension elements. However, the main structure on which the precision and alignment of the mirror ring depends is still a compression structure: the column at the center, constructed as a structural tube. Note also that the tension elements simply lock the ring into its intended configuration with respect to the column; they are not tightened by some repulsive force between the solid structural parts.

Some futuristic ideas have also been proposed in the past with tension elements directly connecting functional device elements, utilizing physical natural force fields (such as photonic pressure, gravity gradient, or centrifugal forces) to preload the tension system. One such idea is the solar parachute concentrator, in which a canopy works as a reflector dish and the satellite is “suspended” at the focus via a filament structure. This and other similar ideas are characterized by very weak preloading forces, weaker than the environmental disturbances to which the structure is subjected to. Consequently, such preloading cannot robustly provide structural precision and uninterrupted integrity against environmental effects. By virtue of relying on weak force fields, such systems are utterly unfit for precision applications. Their potential use is limited to solar sails and solar concentrators in very specific circumstances within the realm of so-called “gossamer” structures, to be fabricated one day in the distant future.

Regular tension structures (which collapse unless tensioned) are also known for space applications. In the general context, every tension element (such as a film sheet of a solar sail space vehicle or every cord-like structural element such as cables, lanyards, etc.) which can bear tension but cannot bear compression could be considered a tension structure.

On some occasions, planar tension structures have been used to ensure the precise planarity of a device configuration. Such designs exploit the fact that, in weightlessness, a sheet or a cable net, if tensioned from a few (typically three) points, assumes a precisely flat shape. Such structures, by definition, are applicable to control a planar device configuration only; their extension to enforce a spatial arrangement of functional device elements is impossible. Further, the stretched shape is not robustly precise, because they resist lateral perturbations only by so-called second order stiffness (stiffness proportional to the magnitude of tension).

Precision tension structures in the more general sense of the word (i.e., structures involving tension elements in a manner that the integrity of the structure as a whole depends on the tensioned state of its tension elements) have also been proposed on a few occasions. A space-borne example is the tension drum idea for mesh antennas, or the tendon dome of virtually any mesh antenna currently in orbit. Any of these (tension) structures would simply collapse if they weren't pretensioned. Tensioned, they work as stiff, efficient structures, able to bear loads and withstand certain disturbances.

Structures for space-based applications, also containing tension elements are disclosed e.g. in U.S. Pat. No. 5,909,197, U.S. Pat. No. 3,913,109, U.S. Pat. No. 4,380,013 and U.S. Pat. No. 5,635,946. Furthermore, U.S. Pat. No. 6,050,526 discloses a deployable structure suspending a reflective film between flexible rods that are rigidly coupled to a solar panel. U.S. Pat. No. 7,806,370 B2 discloses the application of cable diagonals for stiffening purposes.

Apart from space applications and apart from applications relating to precision management of electromagnetic waves, there is a large number of further applications requiring rather stiff functional elements, which are cooperating in the general function of the device (i.e. are cooperatively functional), to be arranged in a relative spatial arrangement (meaning that those are in a predetermined spatial, i.e. non-coplanar position and orientation) with respect to each other. Such applications can be e.g. illumination devices, or decoration.

### DESCRIPTION OF THE INVENTION

An object of the present invention is to provide a simple and efficient structure to hold form-retentive functional elements that are cooperatively functional in their operational state in a predetermined relative spatial arrangement. Form-retentiveness means that the functional elements do not collapse but essentially maintain their form even without any external form-maintaining forces. A further object is to provide structures with form-retentive functional elements and with new stowage solutions that are not possible with prior art technologies. A further object is to provide deployable structures that can open up to their operational configuration in ways different from those enabled by prior art technologies. A further object is to provide new kinds of robust structural forms, and a still further object is to achieve high precision for such purposes. A still further object is to provide easily adjustable structures.

The objects according to the invention have been reached by a structure according to claim 1. Preferred embodiments are defined in the dependent claims.

A major challenge in the engineering of some space-borne apparatus (e.g., reflector dishes, photon sieves, sensor or transmitter arrays) that support the management or the sensing of electromagnetic radiation is the stark conflict between three highly prioritized objectives: apparatus size, precision, and packageability for launch. The herein proposed solution to apply the tensegrity principle directly to “optical” and other device units, optionally coupled with the similarly novel idea of subdividing the device into units not connected by rigid members, solves this challenge. The inventive structure overcomes a known prejudice. It is a general opinion and a preconceived idea widely held by experts in the art, that high precision deployable spatial structures with firm functional elements have to be constructed with a firm structural backbone, to which the functional elements are coupled to ensure their precise and robust relative spatial arrangement. In the realm of this prejudice, prior art tension structures only serve supplementary functions. According to the invention, it has been recognized, that the above objects can be met by tension structures, in which the firm functional elements (consisting of or comprising functional device components) are coupled to each other exclusively by a tension assembly, i.e. their relative spatial arrangement is determined exclusively by a tension assembly. In this case, an inexpensive, simple and low-precision tensioning assembly is sufficient for maintaining an operational state, wherein the tensioning assembly is more compliant than the tensioned structure.

The present invention advances cutting edge (space-based or Earth-based) structural technology by overcoming a limitation of the prevailing engineering thinking. In particular, it enables an entirely new family of apparatus architectures via combining previously separate tension-structure philosophies in a qualitatively new, yet practical way. The structural architectures that arise from this new combination offer entirely new ways to trade in space the conflicting requirements of packageability, equipment size, and structural precision, they allow rapidly deployable light weight apparatus designs on Earth, and they also offer new, attractive and decorative solutions for less technologically critical applications.

In the present invention, the structural tensegrity philosophy is applied to functional elements which are directly engaged in serving the non-structural purpose of the equipment, with structural integrity provided with the concept of structural preloading.

The reliance according to the present invention on tension elements and assemblies as primary and direct means to manage the precise positioning of functional elements breaks with the prevailing engineering philosophy.

The present invention was conceived from a new synthesis of concept elements, in order to offer a new paradigm for the precise relative positioning of relatively stiff elements of (or parts of the elements of) EM and other devices. In particular, individually stiff and separate device elements (or parts of such elements) are integrated into a coherent structural system with a tension structure. This departs from the current paradigm of device integration which involves mechanical members and mechanical hinge, flexure, etc., solutions to connect the elements. It also departs from the application paradigm of tension structures which, so far, have not been used in this role.

The invention thus results in a structure that is different from prior art tensegrity structures, because it is constituted by tension-interconnected form-retentive components being functional with respect to an application device, e.g. dish segments, an antenna feed, a solid frame with a photon sieve within, a light emitter for illumination, etc.

In fact, it is possible that struts and rods aren't even included in the system: in this case the tensioned device structure ends up being comprised of cables and functional elements only.

The preloading of this integrated tension structure can be achieved with any low precision and low cost means (flexed elements, inflatable components, buckled bows, etc.). It is important that this means be structural (not a force field provided by the space environment such as for the space parachute) because this ensures that the preloading forces are sufficient for robustness against environmental disturbances. This robustness is required for structural integrity in all applications, which in space also means resistance to attitude control and other disturbances, while precisely positioning the spatial arrangement of functional device elements.

This paradigm enables that hinges and other mechanical elements which are used according to the prevailing structural paradigm but restrict packaging (and which also have repeatability and precision problems) be replaced with tension elements. The latter are generally easier to engineer and fabricate for precision, and can be easily stowed, allowing much freedom in packaging design. This is the case even if some additional compression elements are embedded in the cord system, such as spreader bars either to suppress vibration modes or to provide some means of geometric leverage for certain length control mechanisms, or for some other reason.

As the invention also permits solid reflector surface elements, it is eminently applicable to visible optical wavelengths, for which multiple meter class devices are on the frontier of current space technology development.

The invention also allows for any of the three prevalent mechanism for displacement and deformation control, essential for optical applications because thermal effects (e.g., sunshine, or heat radiation from the surface of the Earth) and effects of operational dynamics (pointing) alone would otherwise induce deformations in the device beyond what is permissible. These three, passive and active, means of precision control are:
High structural stiffness to suppress transient deformation effects. This can be realized by employing very stiff tension elements. Although such elements would not collapse for stowage like cords or threads but, rather, could only gently bend, they would still offer much more freedom for packaging than current technology.
Active system adjustment with sufficient temporal responsiveness, by continuously tuning and adjusting the structural geometry with actuators at or embedded in the cords' anchoring mechanisms, within the cords themselves, or on the functional elements themselves. Such solutions could compensate transient cord length changes resulting from environmental effects.
The exterior elastic preloading and support structure (which is, by design, compliant with respect to the actual tension-integrated device component assembly) could be designed to also serve as an isolation interface, filtering out dynamic perturbations of certain frequencies from reaching the instrument assembly.

The invention is also applicable to Earth-based devices, enabling efficient packaging for some uses (e.g., hobby telescopes) and giving an elegant appearance to others (e.g., illumination, projection, decorative or entertainment devices).

The two or more functional components cooperatively or collectively serve a direct functional purpose such as e.g. radiation or wave energy management or sensing—for example, to emit, receive, refract, reflect, filter, direct, measure, or generate images from, acoustic or electro-magnetic radiation energy in signal, bulk, or other form (e.g., the components of a space reflector, a photon sieve, the emitter and shade of a floor lamp, or an acoustic mirror); or decoration; or any other purpose.

The invention thus also relates to a structural coupling between one form-retentive equipment element or subassembly and one or more other form-retentive components or subassemblies of the same equipment given that
the coupled components or subassemblies directly serve the manipulation (generation, emission, direction, reflection, focusing, diffraction, filtering, etc.), detection, or processing of spatial and/or temporal energy patterns;
said structural coupling is realized via a tension assembly that may consist of one or more tension elements or may be an assembly or assemblies involving tension elements along with other elements;
the tension assembly that realizes said coupling is tensioned by forces that are exerted by relatively compliant components or subassemblies of the said equipment;
said form-retentiveness of the coupled equipment elements and/or of subassemblies means stiffness sufficient to maintain the approximate relative spatial distances between the locations where the component is externally supported/suspended even if no external loads are exerted on the component, said stiffness being due to the component's internal structural-material and geometric qualities

The relatively compliant components of subassemblies that exert the tensioning forces may involve more than one kind of tensioning structural elements, such as tension, elastic, rigid, stiff, inflatable elements in an organized system. The tension assembly may also include surface (fabric, film) components, and inherently stiff elements (e.g., spreaders) or rigid-articulated-deployable components.

### BRIEF DESCRIPTION OF THE DRAWINGS

Preferred embodiments of the invention are described below by way of example with reference to the following drawings, where

FIG. 1 is a schematic spatial view of a first embodiment, with only some of the cord tension elements depicted,

FIG. 2 is a functional drawing of a part of the embodiment of FIG. 1 showing the distancing forces,

FIG. 3 is a spatial view of a part of the embodiment of FIG. 1, also schematically depicting the couplings,

FIG. 4 is a functional drawing showing the operational and the stowed state of the functional part of the embodiment,

FIGS. 5 to 7 are schematic top views showing the wrapping process of resilient ribs,

FIG. 8 is a schematic top view of a further rib configuration,

FIGS. 9 and 10 show two further aperture structuring options in schematic top views,

FIGS. 11 and 12 show another preferred embodiment in an operational state, in side and top views, respectively,

FIGS. 13 and 14 show the embodiment of FIGS. 11 and 12 in a stowed state,

FIGS. 15 and 16 show an alternative preferred embodiment in an operational state, in side and top views, respectively,

FIGS. 17 and 18 show the embodiment of FIGS. 15 and 16 in a stowed state,

FIG. 19 is a spatial view of a further embodiment in a deployed operational state,

FIGS. 20 and 21 show a still further telescope-like embodiment in a deployed operational state and in a stowed state, respectively,

FIGS. 22 and 23 show a further embodiment of a dual reflector system in an operational state, in a schematic spatial and in a front view, respectively,

FIG. 24 is a schematic spatial view of a stowed state of the embodiment of FIGS. 22 and 23,

FIG. 25 is a schematic view of an embodiment having a tensioning assembly formed as a pressurized envelope,

FIG. 26 is a schematic view of an alternative embodiment similar to that of FIG. 25,

FIG. 27 is a schematic view of an embodiment having a pressurized envelope forming a part of a buoyant structure, and

FIGS. 28 to 31 show exemplary functional elements with dimensions indicated for calculating functional size fraction and functional component gap fraction values.

### MODES FOR CARRYING OUT THE INVENTION

In the context of the application, the following general terms are used with the respective following meanings.

### Structure

Unless otherwise noted, the term “structure” in the present application is used to refer to a physical entity or a set of physical entities that provide(s) mechanical support, such as a bridge structure or a structure holding or including a lens in an optical device. This current meaning is a specific meaning of the word, excluding more general interpretations which also cover the organization of arbitrary, even abstract, elements (such as the structure of a literary work).

### Tension

Tension as an adjective in the structural context (as in “tension structure,” “tension element,” or “tension assembly”) implies the dependence of the structural integrity of the concerned entity on the presence of tension. In other word: a tension structure or a tension element is one that collapses (loses its structural integrity) if not taut (if not loaded with tension). Examples for tension elements include e.g. cords, cables, tendons, filaments, strands, lines, lanyards, chains, strings, ropes, threads, yarns. Examples for tension assemblies and structures include any assemblies consisting of tension elements, and also e.g. spreader systems, sailing boat rig structures, and fabric shelters (tents), etc.

### Stiffness and Compliance

Stiffness is the mechanical resistance of a structure to deformation, while compliance is the deformability of a structure when loaded. Stiffness and compliance are diagonally opposite structural properties. If quantified with scalar quantities, one is the reciprocal of the other: the product of the two equals unity C*K=1 if C denotes compliance, K stiffness.

### Function

The application function of the considered apparatus (equipment). It may be e.g. radio signal transmittal or reception, remote sensing, acoustic wave generation and sensing, seismic monitoring, illumination, decoration, image projection (via mirror and lens setup, etc.), and many other things. A structural purpose alone is not deemed functional in the context of the present invention. Therefore, the words “function” and “functional” in the context of the present document, unless otherwise noted, denote serving a purpose beyond a structural objective.

### Functional Component

A functional component of an equipment is a component directly engaged in the function for which the equipment has been built. Such a component can be a distinct part, a part of a surface or a part of a material volume, a coating on a surface, etc. For example, in a lamp the functional components are all that are directly involved in transforming electric energy into visible light, directing the light via reflecting surfaces or refractive elements, and filtering it for a pleasing color. For a space synthetic aperture radar antenna, the functional components are those directly engaged in generating electromagnetic (EM) radiation from electric energy and the generation of electric signals from EM wave patterns, etc. For a telescope, the functional components are the mirrors, filters, and lenses. For a full telescope-and-camera system, the optical elements of the camera device are also functional components.

### Functional Element

A functional element is part of a piece of equipment distinguished by an overlap of coherent structural form and non-structural function (i.e., an intimate coupling between the element's structure and a non-structural function directly serving the application for which the equipment is built), and further characterized by the following:
The non-structural function in the context of the functional element means that the latter, in its entirety or through one or more of its embedded or attached parts, comprises functional components. It is noted that “comprise” in this and in other contexts of the present application also means “consist of”, i.e. the functional element may solely consist of a functional component, e.g. in case of a decorative function of the element. The functional element typically has one or more functional components fixed in or to a form-retentive enclosure/frame/structure to which the tension assembly is coupled.
The coherence of structural form means that the structural element has a well-defined geometry in its operational configuration, one that is self-maintained (i.e. form-retentive) without the aid of any external effect (tension, preload, gravity, etc.). Also required for the current notion of structural coherence is that, in the operational configuration, the set of locations on the element to which other equipment parts (external to the element) are attached have a fixed geometry that doesn't substantially collapse when the external forces exerted on said locations are removed. Tension or preloaded assemblies (such as a membrane stretched within a frame, or tensioned cables and/or other components suspended) are permitted within a functional element. A functional element can also be folded or otherwise collapsed for stowage.

### Preferred Dimensional Characteristics of the Functional Elements

The invention applies to devices with any kinds of functional element as defined above, regardless of functional element shape, size, or internal structure. However, the more closely the structural form overlaps with the functional form for the elements, the more profound the packaging benefits are. The overlap of structural form with non-structural function for an element is herein quantified with two metrics. The first, the functional size fraction, quantifies how closely the size of a functional element corresponds to that of the set of its functional components. The second, the functional component gap fraction, quantifies how densely the element is populated with functional components.

The functional size fraction is herein specified as the ratio of the functional diameter to the geometric diameter, with the functional diameter defined as the diameter of the smallest sphere that fully encloses in its interior all functional components, and the geometric diameter defined as that of the smallest sphere that encloses in its interior the entire functional element itself.

The functional component gap fraction is also expressed as the ratio of two geometric dimensions. The first, in the enumerator, is the largest component population gap that can be measured between groups of functional components, as described next.

To calculate the largest component population gap, first replace each functional component with its circumscribing sphere: the smallest sphere outside of which no part of the component extends. The largest component population gap is the largest gap that can be measured between these spheres, via the help of a plane that is positioned in space such that at least one component-circumscribing sphere lies on each of its sides, while the plane does not intersect any of the component circumscribing spheres. In particular, for each such plane position a gap size can be obtained as the sum of the smallest distance from the plane to the nearest sphere on each side. Accordingly, each plane position defines a gap size; the maximum such size of all possible plane positions is the largest component population gap. In case no plane can be found to satisfy the above placement criteria, the maximum component population gap is zero (0).

The denominator of the ratio defining the functional component gap fraction is the element functional diameter, defined above. Accordingly, the functional gap fraction is the ratio of the largest functional component population gap to the functional diameter of the functional element concerned.

Experience with deployable structures design suggests that, although the invention applies to devices with functional elements of any functional shape and structure, the benefits of the new ways of packaging offered by the invention are likely be significant for devices with functional elements that have functional size fractions at least 1/10 and functional component gap fractions at most 9/10. Within this range, the same advantages can actually be striking if the functional size fractions are at least ⅓ and the functional component gap fractions at most ⅔.

### Preferred Dimensional Characteristics of the Entire Structure

The invention applies to any spatial positioning of any functional device elements with self-sustained, stable shapes. This scope means that the geometry of the set of functional components served is a spatial one, and their positioning is maintained with a spatial arrangement of tension elements (rather than with tension elements arranged within a single plane or along a single straight line). Generally speaking, the more pronounced the spatial nature of the functional component configuration (across the entire set of functional elements), the more significant the advantages enabled by the invention. Experience with deployable structures design suggests that new packaging options enabled by the invention will offer generally significant benefits for devices wherein the ratio of a largest dimension to a smallest dimension of the smallest convex envelope enclosing the complete geometries of the functional components is less than 10, and said benefits can actually be dramatic if this ratio is less than 5.

### Tension Elements, Tension Assembly

An individual element and a set of coupled elements, respectively, the structural integrity (i.e., shape and load bearing capability) of which is contingent upon a state of pretension/preload. Without the preload, the element or assembly loses its shape (collapses) in full or in part. Tension assemblies may have non-tension elements or sub-assemblies. Examples of such non-tension elements are spreaders in a cable system, or bars in a tensegrity structure. The structural advantages of tension structures include more flexibility in stowage design for deployable structures, simpler structural effects (no buckling) and lower weight, easier engineering for precision, etc. The non-structural advantages may include visual elegance, more transparency, etc.

### Tensioned Assembly (Tensioned Functional Assembly)

An assembly of two or more functional elements interconnected with the tension assembly (coupled by couplings to the functional elements), such that the whole, when properly tensioned, is sufficiently stiff and precise to properly position the functional elements with respect to each other (required stiffness and precision varies from application to application). A tensioned assembly may be tensioned with one or more tensioning assemblies. According to the present invention, the functional elements in the tensioned assembly are spatially arranged.

### Tensioning Assembly

An assembly of mechanical and structural components that exerts loads on a tensioned assembly in order to guarantee the required tautness (state of preload) in the tension elements of the latter. The exerted loads must be sufficiently high to maintain this objective even if additional forces due to gravity or other disturbances appear, because these disturbing forces may reduce the tension in some of the tension elements. There are also other criteria that influence the desirable magnitude and configuration of pretensioning forces and, thus, the design of a tensioning assembly. There can be several tensioning assemblies cooperatively exerting preload on a single tensioned functional assembly. In the inventive context, a tensioning assembly has to be more compliant (=less stiff) in its effects on the tensioned assembly than the latter. This is needed to reduce deformations in the tensioned assembly due to deleterious effects which include imperfections in the tensioning assemblies themselves, as well as dynamic and other disturbances. In particular, the geometric and other errors of the tensioning assembly don't propagate fully to the tensioned assembly if the former is more compliant, because this compliance results in the tensioning structure itself absorbing the majority of the geometric errors.

### Actuators

Devices that can be mounted on or embedded in any equipment component (cable, coupling, shell, rod, mounting of optical element, an RF functional component itself, even parts of the tensioning assembly, etc.) that can undergo deformations on demand and, as a result, can cause a change in component shape or configuration geometry. Actuators are often used to reduce the effects of imperfections and perturbations. In the former role, they can contribute to fine-tuning a configuration geometry or to compensating shape and dimensional errors, in order to improve device accuracy. In their latter role, they can counteract quasi-static environmental effects (e.g., thermal deformations) or help dissipate energy in a dynamically perturbed system according to various control strategies.

### Support

A structure according to the present invention could be externally supported in a variety of ways. These include support for (points on/elements of) the tensioning assembly, the functional elements, or the tension assembly itself. In space, no external support is needed. However, in space a structure according to the invention may be coupled to other spacecraft subsystems at any of its parts.

### System Compliance

The mechanical effects that realize the coupling between the tensioned assembly (which is constituted by the functional elements “embedded” in a tension structure and coupled to same by means of couplings) and the tensioning assembly are a set of forces and/or moments. This set is exerted on the tensioned assembly, making taut the tension elements therein. At the same time, the reaction forces of (effects opposite to) this set are exerted on the tensioning assembly. Consider the tensioned assembly separately in its functional state, but with the tensioning assembly replaced with the set of forces and moments it exerts. Increase the magnitudes of these effects with 1%. As a result, the tensioned assembly will deform: displacements and rotations will appear at each of the locations where the tensioning effects are exerted. Calculate the work that the original tensioning effects (forces and moments before the increase) perform over this displacement field, by multiplying each effect with the associated displacement of the tensioned structure. The absolute value of this work (i.e. the sum of the work-items so calculated) is a measure of the compliance of the structure; let this be herein referred to as the system compliance of the tensioned assembly in the context of the considered increase of tensioning effects.

Now let's generate the same system compliance for the tensioning assembly as well. First, consider it separate from the tensioned assembly by replacing the latter with the effects it exerts on the tensioning assembly (the reaction of the tensioning effects). Increase these loads with 1%, and generate the same system compliance measure as the work done by the original effects (before the increase) on the displacements resulting from the increase.

Design experience suggests that the advantageous effects of simplified precision management offered by the invention can already be achievable if the system compliance (as defined above) of the tensioned assembly is less than 60% of that of the tensioning assembly. Applications with such a compliance ratio likely include precisions that don't call for expensive engineering and fabrication solutions, and are not highly sensitive to imperfections. Examples include most decorative uses, simple illumination devices, and acoustic functions. For more error-sensitive applications, which include radio and some radar devices, this ratio has to be less than 25% for the device construction to be easily engineered for low cost and sufficient robustness against certain geometric errors. For equipment serving more technologically aggressive applications (for example, higher frequency EM devices, such as other radar- and optical equipment), system compliance for the tensioned assembly less than 10% of that of the tensioning assembly will likely be required to easily make a design clearly attractive in terms of the cost-effective management of precision. In fact, for certain design solutions, the concerned system compliance ratio may have to be less than 5% or even less than 1%, for various reasons.

However, regardless of the concerned system compliance ratio which affects how easily the invention's benefit of simple precision management can be realized, the other revolutionary benefit of the invention remains unaffected by this metric. Namely, new packaging (stowage) and deployment solutions that wouldn't be possible with existing technology are enabled (because existing technology highly restricts stowage and deployment design due to the known prejudice of avoiding large compliant substructures and critically relying on solid support structures and articulated systems in the spatial positioning of functional device elements with self-sustained shapes).

Turning now to the embodiments depicted in the Figs., the same reference numerals are used throughout the figures for denoting the same or similar elements. The figures are minimalistic in the sense that they do not show complete systems, only elements of systems necessary for the illustration of the invention. For example, antenna feeds or imaging units are not depicted in many of the figures.

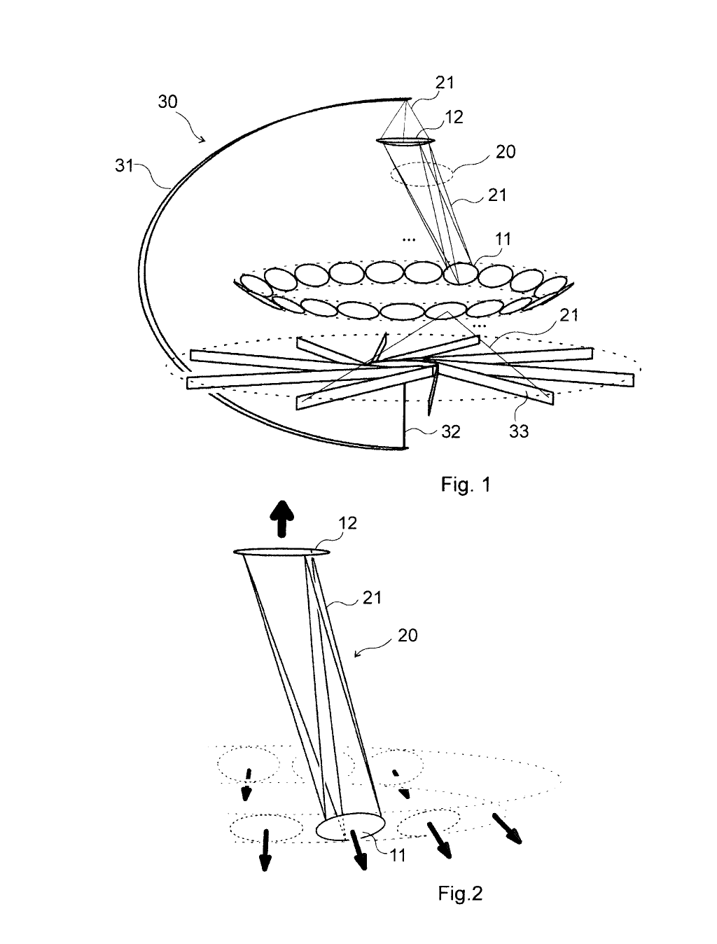

FIG. 1 shows an example of a Cassegrain architecture having primary dish units as first functional elements 11 and a secondary mirror being a second functional element 12. The functional elements 11, 12 are form-retentive and are cooperatively functional in the depicted operational state of the structure, in the operational state the functional elements 11, 12 have a predetermined relative spatial arrangement and are distanced from each other.

A tension assembly 20 couples the functional elements 11, 12 to each other. The tension assembly 20 is adapted to be taut in the depicted operational state and is coupled to the first functional element 11 by respective first couplings and to the second functional element 12 by respective second couplings. The functional elements 11, 12, the couplings and the tension assembly 20 together forms a so called tensioned assembly. The tension assembly preferably comprises tension elements 21, which are cords in the depicted embodiment but also may be selected from a group consisting of: cable-like elements, fabric-like elements, chain-like elements, net-like elements. The collapsible interconnecting tension elements 21 have opposite ends, the opposite ends of a tension element 21 is attached to two respective elements of the structure, thereby interconnecting the two respective elements with each other. The lengths of the tension elements 21 determine the shape of the operational state including the predetermined relative spatial arrangement of the functional elements 11, 12.

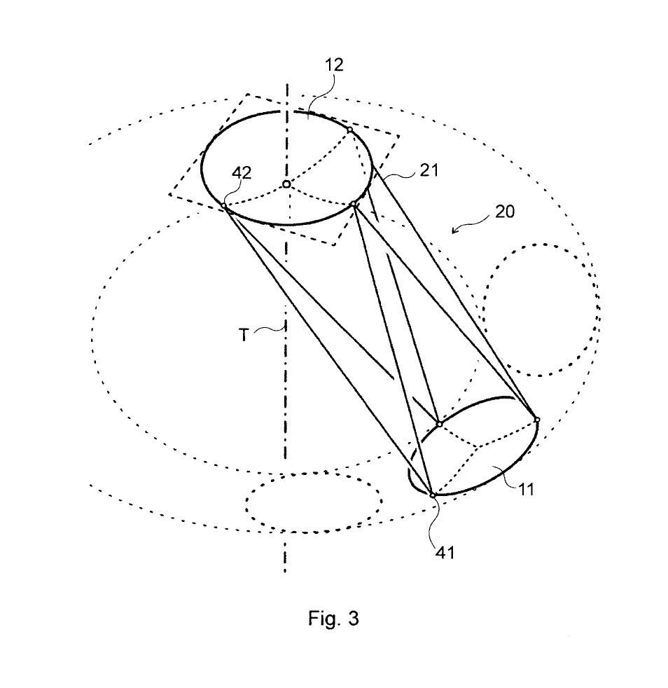

In the tension assembly 20, as also in FIGS. 2 and 3 depicted, preferably at least six tension elements 21 are interconnecting each first functional elements 11 with the second functional element 12 (interconnections of only one first functional element 11 are shown). In this Stewart platform-like arrangement, the three linear movements x, y, z (lateral, longitudinal and vertical), and the three rotations pitch, roll, yaw, can be effected between the functional elements 11, 12, enabling an efficient and exact relative positioning between the functional elements 11, 12.

Preferably, the tension assembly comprises six tension elements 21, and three couplings for each of the first and second functional elements 11, 12. As depicted in FIG. 3, each first coupling 41 is interconnected with two second couplings 42 by two respective tension elements 21. In this way the structure can be built with a minimum number of couplings and still with a full determination of the relative spatial arrangement.

However, the number of tension elements 21 can also be more than six for any functional element. Such a design may be motivated by the need for structural redundancy. In some cases in which device application requirements, environmental conditions, and structural considerations permit, fewer than six tension elements 21 may also be permissible. Shading, decorative, illumination, or acoustic applications may easily fall in this category, but it is not inconceivable that more technical uses of the innovation also permit less than six tension element coupled to a functional element. An obvious case is when the tension elements include at least one sheet-like (fabric, film, etc.) element. However, even with cable-like elements only, cases with less than six tension elements are possible. In such configurations, certain displacements of the functional elements are suppressed not by the direct material stiffness of the tensioned system, but by so-called second order stiffness effects.

Returning back to FIG. 1, the structure also comprises a tensioning assembly 30 coupled to the tensioned assembly. The tensioning assembly 30 is a spring-like element 31 formed as an elastic bow, which is adapted to exert a repulsive force—depicted by arrows in FIG. 2—distancing each of the first functional elements 11 and the second functional element 12 for maintaining the operational state. The spring-like element 31 is arranged to urge the first functional element 11 and the second functional element 12 to their predetermined relative spatial distanced arrangement.

According to the invention, the system compliance (see above) of the tensioned assembly is less than 60% of the system compliance of the tensioning assembly 30. There are applications where this system compliance ratio enables to design a tensioned structure having all the advantages detailed throughout the present application, while a simple, inexpensive, low precision, more compliant tensioning assembly can be applied for maintaining the operational state. The operational arrangement of the functional elements and precision are determined by the tensioned structure. Imperfections of the more compliant tensioning structure do not deteriorate this geometry beyond acceptable limits because, by virtue of its lower stiffness, the tensioning structure itself absorbs the greater part of the geometric errors that arise from imperfections, without imposing non-manageable deformations on the tensioned structure.

For other, more error-sensitive applications, the full benefits of the invention can only be realized if the system compliance of the tensioned assembly is less than 15% of the system compliance of the tensioning assembly. However, the other major benefit of the invention, the existence of new stowage design options that wouldn't be possible with traditional technology, is independent of how the two tensioned and tensioning assemblies' system compliances relate to one another.

The depicted tensioning assembly 30 has opposite ends. The upper end in FIG. 1 is coupled indirectly, via upper peripheral tension elements 21 to the second functional element 12. Below the tension assembly 20 and the first functional elements 11, lower peripheral tension elements 21 are present to connect the first functional elements 11 to radially arranged resilient elements 33 forming the end(s) opposite to the upper one (again, interconnections of only one first functional element 11 are shown). It can be seen that mutual relative spatial arrangement of the functional elements 11, 12 are fully determined by the tension assembly 20 between them, so the peripheral tension elements 21 only serve for exerting the repelling force distancing the functional elements 11, 12. It is conceivable that any number (even one) of peripheral tension elements 21 may be sufficient for each functional element 11, 12, if a repellant force in the distancing direction can be exerted therewith.

The resilient elements 33 are attached by means of a shaft 32 to the lower end of the elastic bow. In the depicted preferred embodiment, the tensioned assembly has peripheral elements (i.e. tension elements 21 attached to the upper end of the spring-like element 31 and to the radially arranged resilient elements 33) arranged oppositely in the tensioned assembly with respect to the tensioning direction, i.e. the direction in which the functional elements 11, 12 are distanced for cooperative functionality. The ends of the tensioning assembly 30 are coupled to these peripheral elements, respectively.

FIG. 3 shows that the tensioned structure preferably has a rotational symmetry around axis T and depicts the taut tension assembly 20 in the operational state. The tension assembly 20 is coupled to the first functional element 11 by respective first couplings 41 and to the second functional element 12 by respective second couplings 42. The couplings 41, 42 can be realized in any conceivable way and are not detailed further.

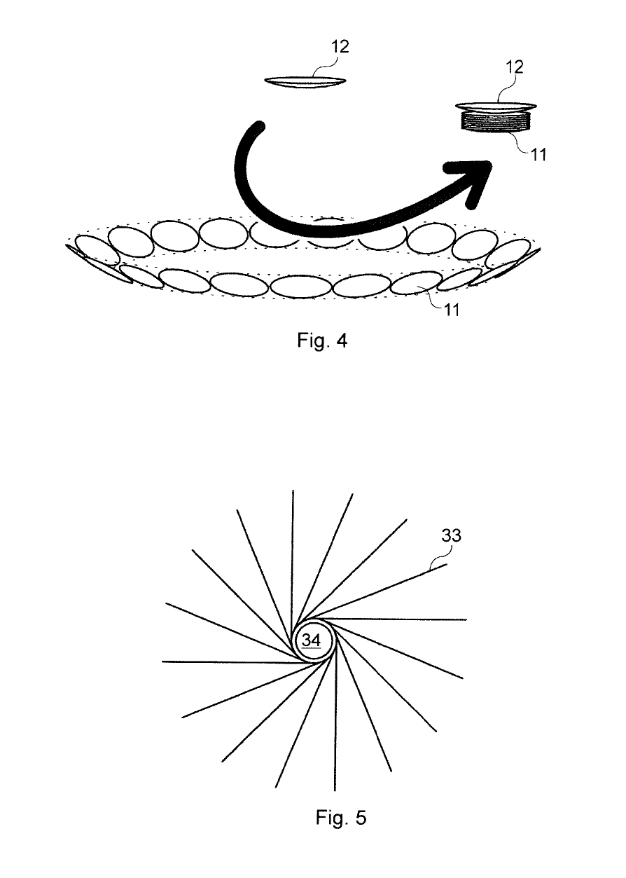

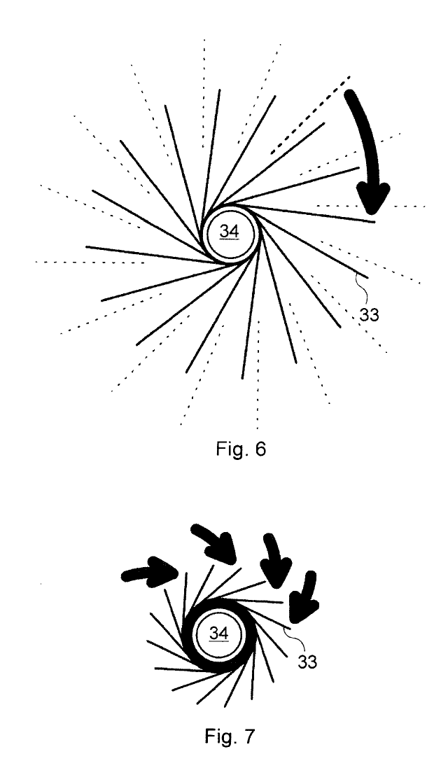

FIG. 4 schematically shows the structure of FIG. 1 in a deployed state corresponding to the operational state, that can be packed into a compact stowed state in which the tensioning assembly 30 is in a preloaded state. It can be seen that the inventive idea of interconnecting and positioning functional elements with each other by means of a tension structure—maintained by a more compliant tensioning assembly—enables to achieve an extreme low volume stowed state, as cords collapse and easily fit between and under the dish units in stowage. The elastic bow can be wrapped, coiled, or otherwise packed for stowage. The resilient elements 33 are preferably ribs which are wrappable around a hub 34, as depicted in FIGS. 5 to 7.

FIG. 8 shows that the resilient elements 33 can also have a branched or otherwise hierarchical structure, wherein anchor points can be e.g. at the ends and at the branching points of or anywhere else on the ribs.

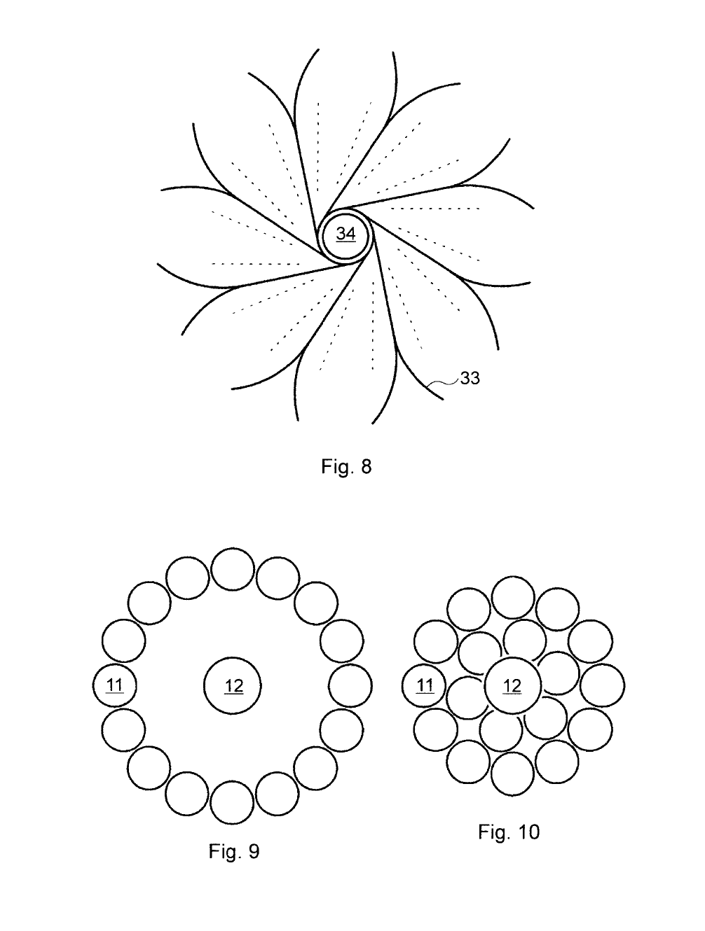

FIGS. 9 and 10 show two further aperture structuring options, in which multiple tiers of units reduce the deployed diameter, and thus the size of the other structural and optical elements. Such aperture structuring options require multiple anchor points on the ribs.

The embodiments depicted so far have a simple structure and enable to ensure precision with cords. A compact stowed state is also ensured by the wrappable ribs and by the compliant bow. They has an easily scalable design and are robust when deployed. Any tension element (and any of the functional elements and any auxiliary element at the anchor points, couplings) can be coupled with piezoelectric or other actuator devices to directly or indirectly change the tension element's effective length and, thereby, coarsely adjust and/or finely tune the configuration geometry of the tension structure.

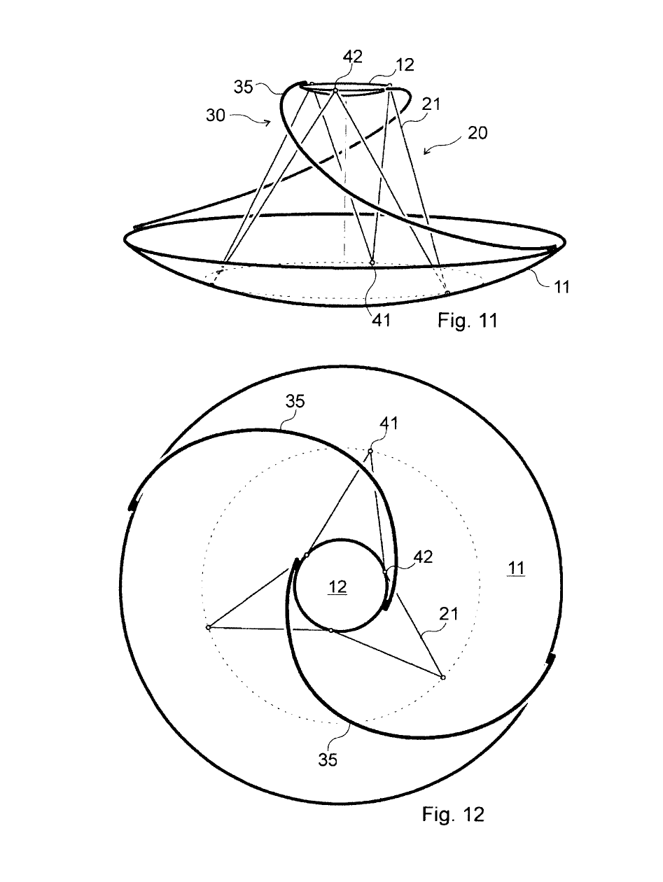

FIGS. 11 and 12 show another preferred embodiment in an operational state, having a main dish as the first functional element 11 and a feed or secondary optics as the second functional element 12. The tension assembly 20 is again arranged in a Stewart platform-like arrangement. The tension elements 21 are cords, attached via first couplings 41 to the first functional element 11 and via second couplings 42 to the second functional element 12. The tensioning assembly 30 here comprises two spring-like members 35 formed in a spatially spiraling manner.

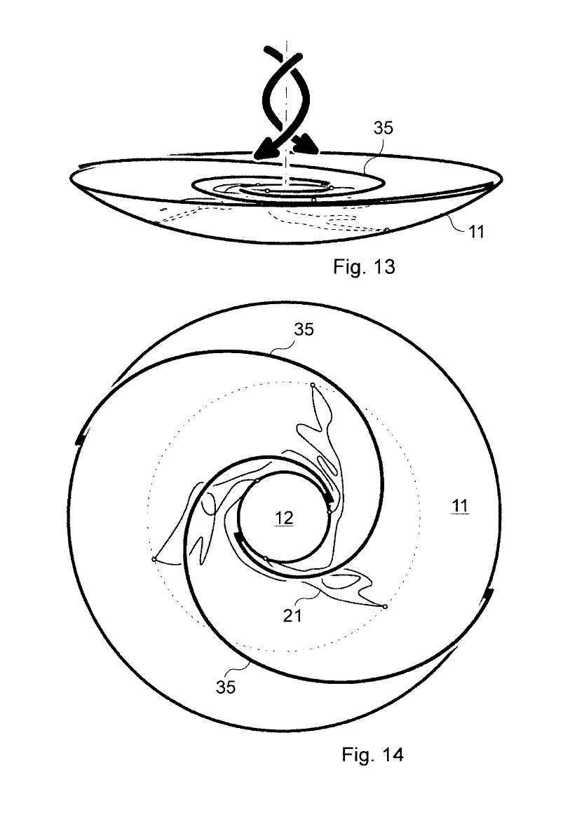

FIGS. 13 and 14 show the embodiment of FIGS. 11 and 12 in a stowed state. It can be seen that an easy and efficient packaging is possible, being advantageous especially for space-based applications.

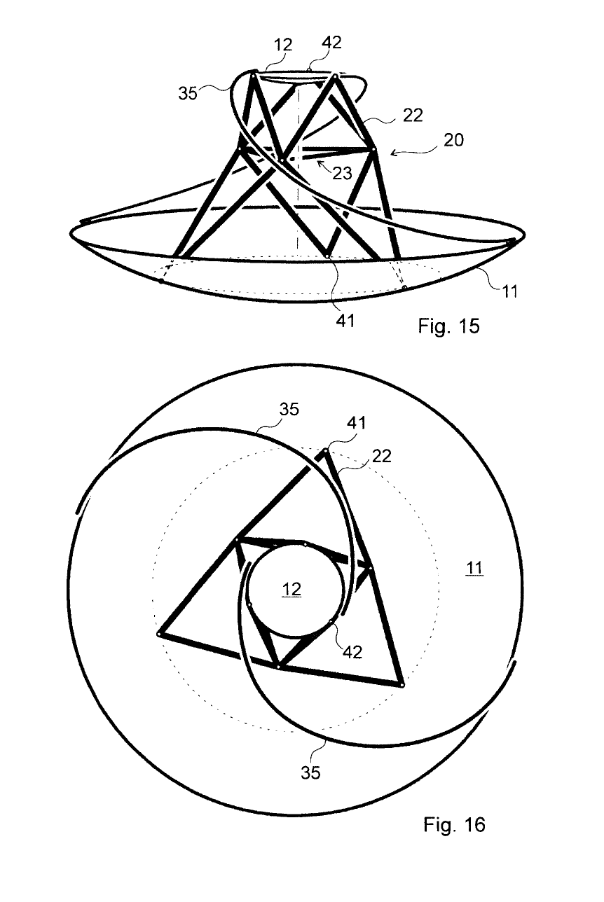

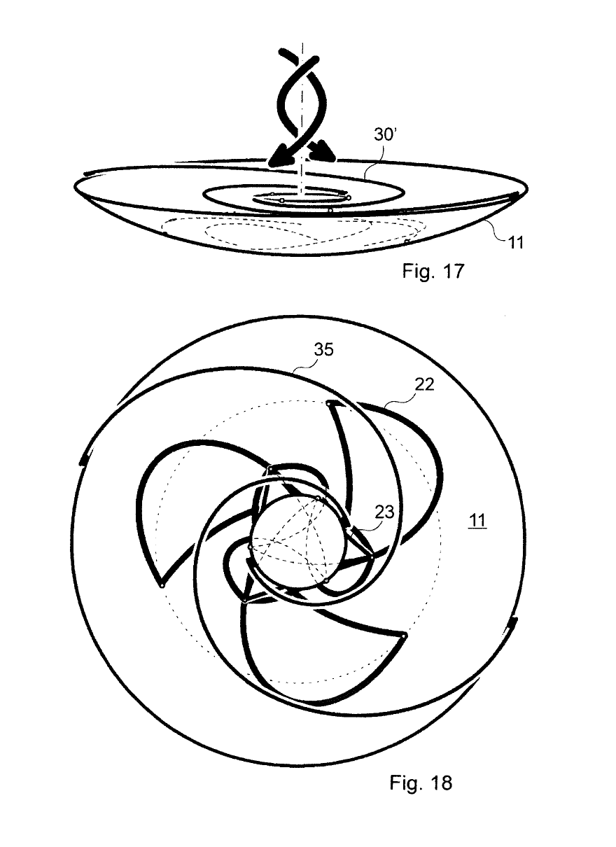

An alternative embodiment is depicted in FIGS. 15 to 18, which only differs from the previous one in that the cord tension elements 21 are replaced by thick tension elements 22 for providing high stiffness. The thick tension elements 22 bend, rather than shapelessly collapse, in stowage. A triangle 23 at the middle of the tension assembly 20 is preferably a solid spreader element, being an example of embedding solid components in the tension assembly 20.

The configuration illustrated by embodiments in FIGS. 11 to 18 is eminently applicable to manage any energy pattern or form: it can be a blueprint for radio, radar, optical, or acoustic devices, including simple solar heaters. Axisymmetric or offset configurations are both possible, although FIGS. 11 to 18 only illustrate an axisymmetric configuration. The elastic tensioning element can be a single curved member, or a plurality of curved members—the Figs. shows two identical curved members as an example. The feed (alternatively, emitter, secondary optics, etc.) can be directly attached to the elastic spring-like element(s) or can be suspended from it (them) with tension elements—the Figs. show a direct attachment as an example. The tension elements 21 can be attached directly to the feed or secondary optics elements, or can be attached to bars or other protuberances emerging from/attached to the positioned feed or secondary optics element—in the Figs. a direct attachment is shown only. If needed, the elastic element can be transparent to the radiation managed (e.g., for an RF dish it can be made of fiberglass). The part of the elastic tensioning assembly attached to other components (in this example, to the dish and the feed/secondary) may involve any convenient interface solutions such as cords, sheet elements, flexures, hinges, etc.

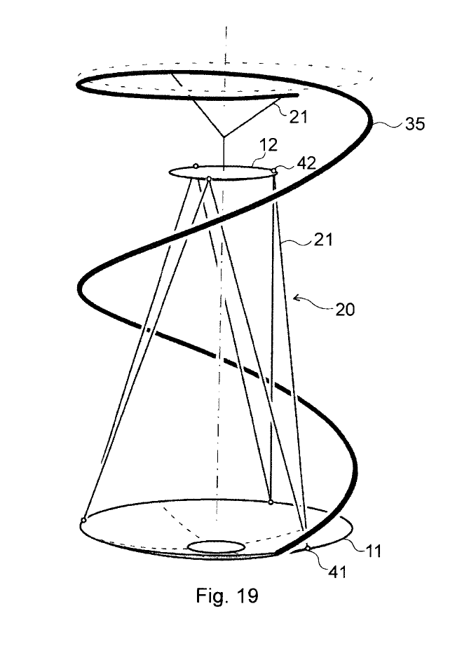

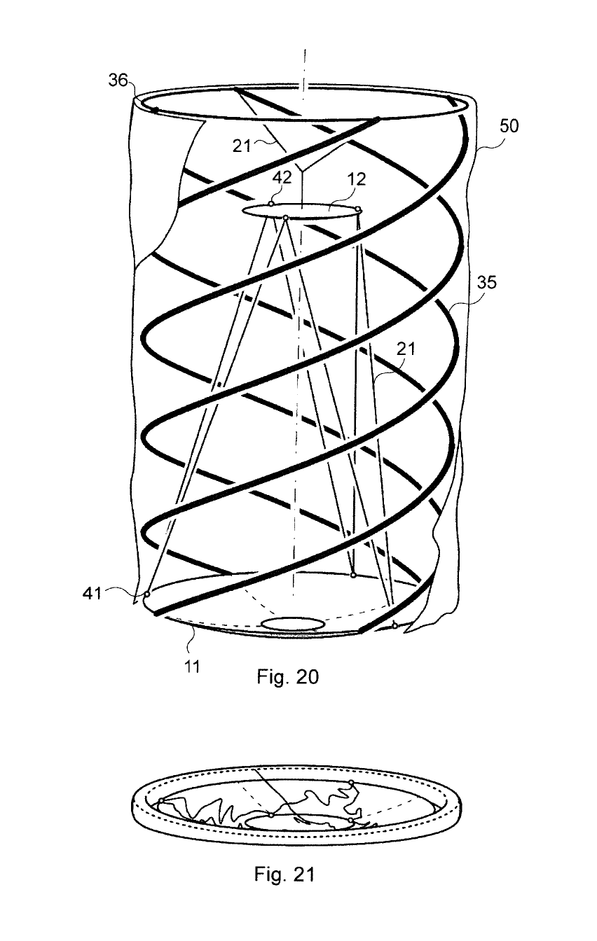

A further embodiment is depicted in FIG. 19 in a deployed operational state, the embodiment preferably forming a telescope-like device. The tensioning assembly 30 in this case is a single spiraling elastic spring element, being a spring-like member 35. The first functional element 11 is a primary optics and the second functional element 12 is a secondary optics. Tension elements 21 (cords) structurally couple the device components to each other. At the top of FIG. 19, a secondary tension link is visible, which couples the second functional element 12 by means of cords as tension elements 21 to the tensioning assembly 30. As the relative spatial position/orientation of the functional elements 11, 12 is fully determined by the tension assembly 20, the secondary link may be coupled to the second functional element 12 even by a single coupling.

FIG. 20 shows a still further telescope-like embodiment, in which the tensioning assembly 30 comprises multiple spring-like members 35 formed in a spatially spiraling manner. A collapsible cover 50 (e.g., a fabric “tube”) is arranged around the structure, and the spring-like members 35 are attached to a ring 36 which synchronizes the tensioning effect and holds the cover 50. FIG. 21 shows that a highly compact stowed state can be achieved for the telescope of FIG. 20; all components collapse to compactly stow over, in, and around the primary optics.

The embodiments in FIGS. 19 to 21 show that one or more tensioning spring can be used for maintaining the operational state. The secondary optics can be suspended from the elastic tensioning elements or can be directly attached to them—the former option is shown only. Tertiary optics (e.g., an eyepiece) can be additionally coupled to the secondary or the primary optics shown, with an appropriately extended elastic tensioning system (additional spring elements). The cover 50 may serve to prevent stray light to reach the optics from the sides, and may be integrated with the system for space deployment as well as for Earth-based applications. The elastic spring element(s) may be embedded in/with the cover (similar to some collapsible household “laundry basket” storage devices) or may be independent from it along their lengths, with the upper rim of the cover attached to the spring top ends (or to a ring supported thereby).

In FIGS. 19 to 21 functional elements of the telescopes other than the mirrors are not shown for simplicity. However, other functional elements—e.g., and eye piece assembly or a camera—could also be added to the system, by a suitable extension of the tensioned system and additional tensioning system elements.

The possible applications of the telescope-like configurations according to FIGS. 19 to 21 are not limited to actual telescopes. For example, directed radiation energy devices, e.g. laser beam forming and targeting equipment can also be build according to these embodiments, with suitable functional elements.

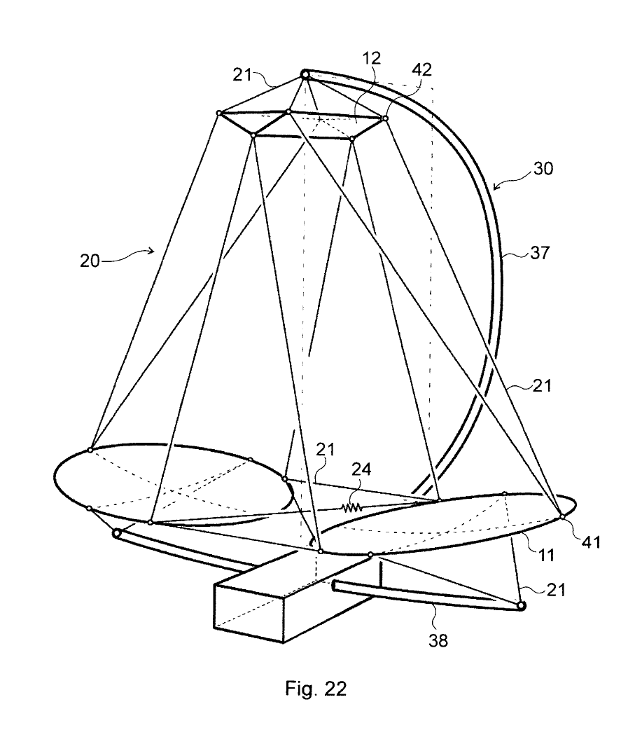

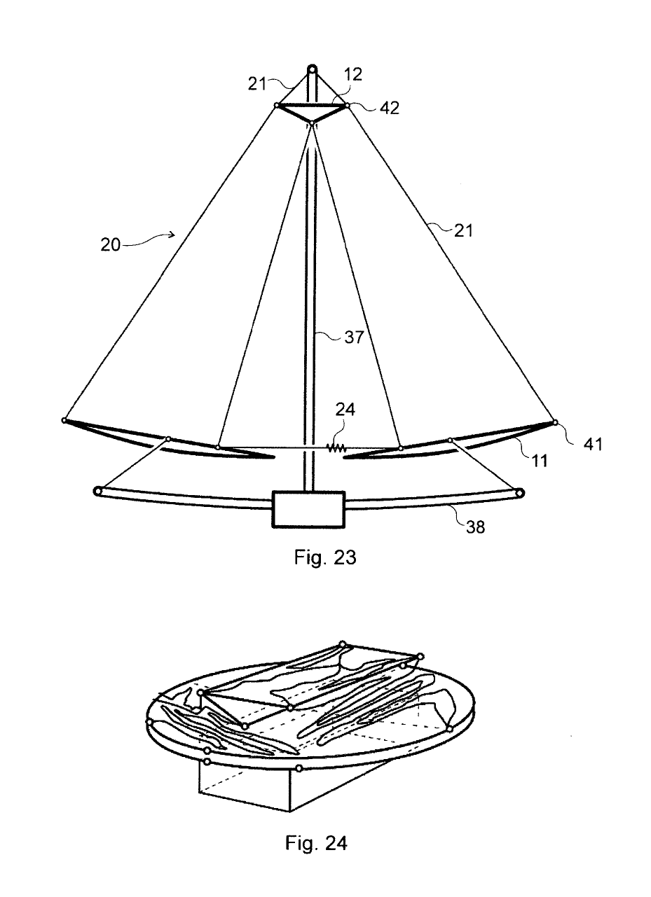

FIGS. 22 to 24 show a further embodiment being a dual reflector system. There are two first functional elements 11 being primary reflector dishes and one second functional element 12 being a secondary optics. The tensioning assembly 30 comprises an elastic bow, being an inflatable arch 37, and elastic base bars being also inflatable bars 38. Cords as tension elements 21 couple the functional elements 11, 12 to the ends of the inflatable arch 37 and of the inflatable bars 38. Further tension elements 21 are interconnecting the first functional elements 11, thereby defining a fixed spatial arrangement. A spring insert 24 may be included in one of these further tension elements 21 if required (depicted). The inflatable arch 37 and the inflatable bars 38 are fixed to a base subsystem. FIG. 23 shows the structure in front view, while FIG. 24 shows the structure in a stowed state.

In the embodiment in FIGS. 22 to 24, the coupling tension assembly 20 is an interconnected system: the primary reflector dishes are coupled not only to the secondary (or the feed) but also to each other. The compliant tensioning system includes different elements that are not interconnected and are separately located: the bow, the cross bars, and a cord with a spring between the two primary dishes. The primary dishes are pulled “apart” also, not only “down”, in order to maintain tension also in the cords between the two dishes. The secondary/the feed and the primaries are schematically shown. Any reasonable shape could be accommodated. The form shown as the subsystem base is a “placeholder” for a compact package which preferably includes an inflation device. The functionality of the subsystem base (storage) and the base bars (support) can alternatively be provided by a single support structure (e.g., the satellite bus) itself.

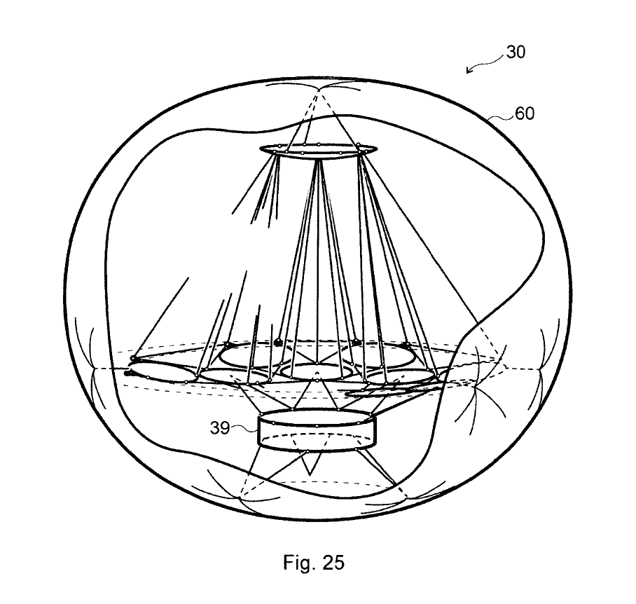

According to a preferred embodiment shown in FIG. 25, the 30 tensioning assembly comprises a pressurized envelope 60 and the tensioned structure is located in the interior of the envelope 60, also including a receiving unit 39. The similar embodiment of FIG. 26 has a receiving unit 39 arranged partially outside the pressurized envelope 61 for easy maintenance. This embodiment also has a functional element 12 integrated into the wall of the envelope 61.

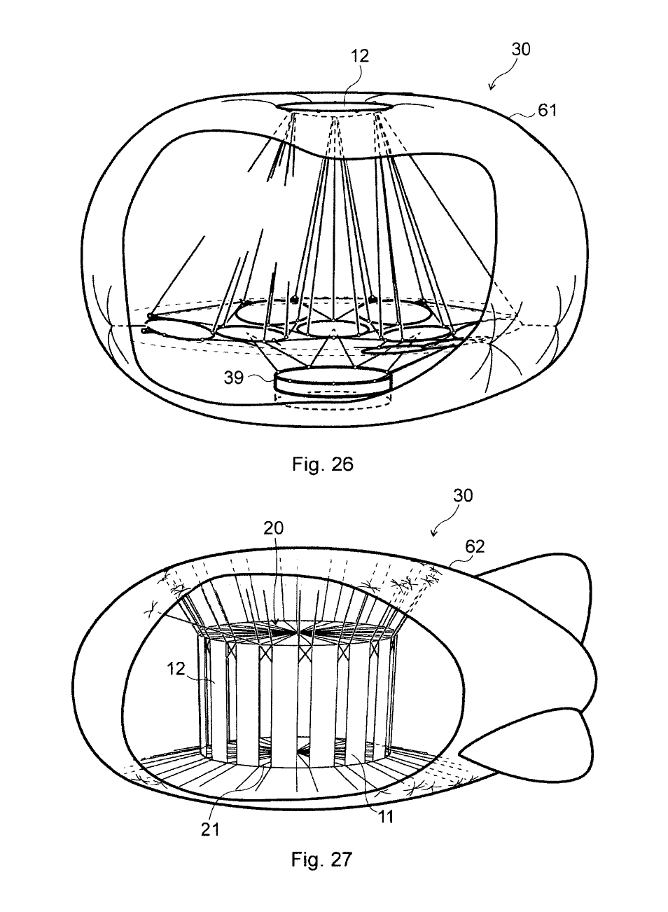

In FIG. 27, the embodiment has a pressurized envelope 62 forming a part of a buoyant structure (the Fig. shows a blimp). The functional elements 11, 12 therein are strips, aligned on a curved surface. The functional elements 11, 12 are interconnected with the tension assembly 20, which comprises cord-like tension elements 21. In the example shown, this surface resembles a cylinder. Typical application: the functional components populating the strips are electronic units, emitting or responding to RF or radar wave patterns.

The above three embodiments in FIGS. 25 to 27 are not specific to any particular environment or technology. Pressurization can be effected with a gas or a liquid, the environment could be space, air, or under water, the wall material of the pressurized envelope can be film, fabric or any other suitable sheet material. Furthermore, functional elements such as dishes or strips can be integrated into the wall of the pressurized envelope 60, 61, 62. This will also influence the shape of the envelope 60, 61, 62.

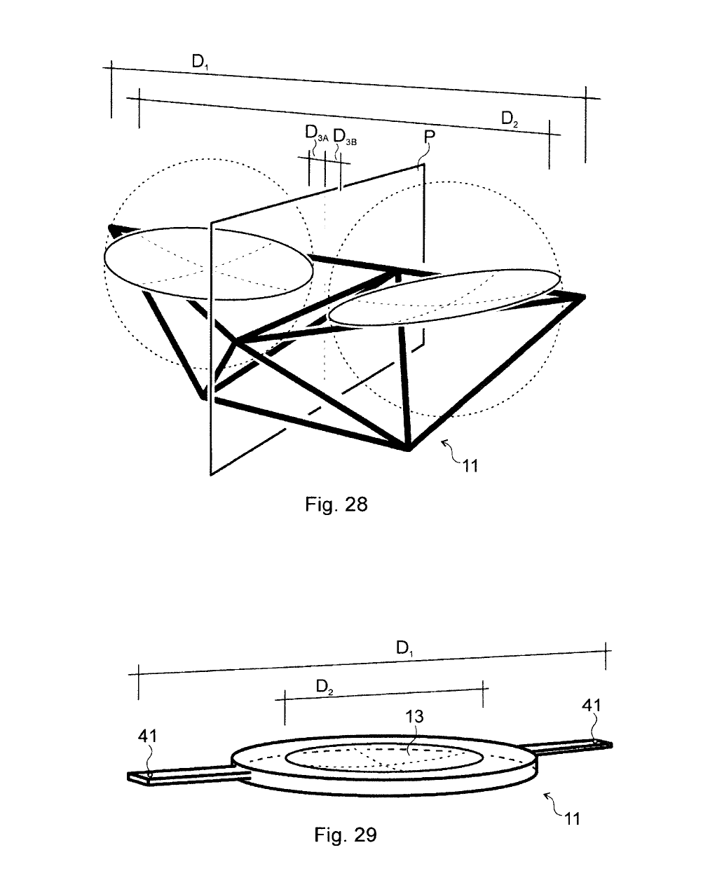

FIG. 28 shows an exemplary functional element 11 with two reflector dishes fixed to each other by a rigid lattice-work structure. Shown are the dimensions that will produce the functional size fraction (D₂/D₁) and the functional component gap fraction ((D_{3A}+D_{3B})/D₂) as defined above, taking into account plane P for the calculation.

FIG. 29 shows a functional element 11 example with a single dish surface, with a structural brim and cantilever appendages for mounting the couplings 41. Shown are the dimensions from which the functional size fraction (D₂/D₁) can be calculated. The functional component gap fraction is zero.

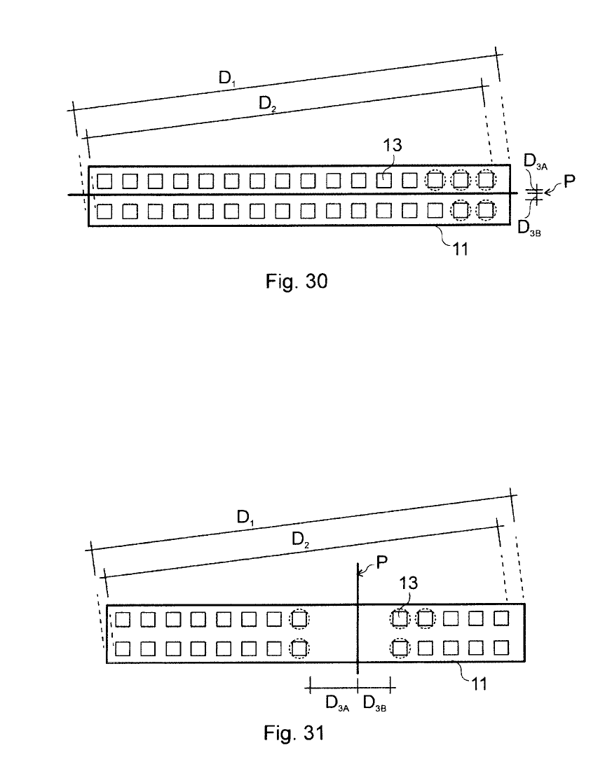

The same dimensions are used to calculate the above fractions for the embodiments in FIGS. 30 and 31, showing functional elements 11 typical for some RF or radar operations. The functional components therein are electronic units 13 that cooperatively sense or generate EM wave patterns. They are mounted on a plate strip. Shown are the dimensions that will produce the functional size and the functional component gap ratios. In case of FIG. 31, the component gap ratio will be higher because there is a pronounced gap between the areas populated by the electronic units 13.

Although the invention has been described in connection with preferred embodiments depicted in the drawings, many further modifications, alternatives or developments are possible without departing from the general inventive idea.

It is conceivable that the functional elements may also comprise (i.e. may consist of or may have) functional components being cooperatively functional with respect to electromagnetic waves. Preferably, the functional components are selected from a group consisting of: generating components, emitting components, directing components, reflecting components, scattering components, coloring components, focusing components, diffracting components, filtering components, transmitting components, shading components, blocking components, sensing components, polarizing components, measuring components, projecting components and image or signal capturing components. Cooperatively in this context means that those are cooperatively contributing to the general function of the equipment. For some technical applications, preferably, the 30 tensioning assembly or the tension assembly is transparent to the electromagnetic waves managed, so those do not deteriorate the required function. For some other applications, e.g. for acoustic, decorative, illumination, or photographic uses transparency may not be required.

A functional element may have a folded deployable state, and a fixedly opened state for said operational state of the structure, in which fixedly opened state the functional element has a shape-retentive quality. Alternatively, the functional element can be formed as a non-folding structure, the shape of which is steady and non-changeable.

If active adjusting of the dimensions of the structure is necessary, an actuator device may be coupled either to a tension element 21, to a coupling 41, 42 of the tension element 21, to a functional element 11, 12 or to an internal non-tension element of the tension assembly. The actuator device is preferably adapted to adjust the relative distance and/or orientation between the functional elements 11, 12.

The tension assembly may further comprise element(s) selected from a group consisting of: articulated deployable elements, spreader elements, interconnecting elements. Like-elements are understood to also include the same elements, e.g. cable-like elements are understood to also include cables.

The tensioning assembly 30 may comprise an elastic, a spring-loaded, a pneumatic, an inflatable or a hydraulic element.

The system elements, variations, and options shown or discussed in the context of the embodiments are “modularly” applicable to any of the design configurations illustrated or others that can be derived, despite that they may have been highlighted via a select embodiment only. A multitude of design and configuration variations exist for the tension structure that stiffly couples the device components. The examples illustrated are simple examples. It is also noted that the depicted embodiments may also comprise further elements or components, as required by the given application.

Although the structural connections between the concerned device elements is achieved via tension components or tension subsystems, the external support of the entire device may still be achieved via the traditional external support of selected device elements or any other component or subsystem of the assembly.

Technical benefits of the invention are e.g. the following:
the functional elements are separate, they can be easily stowed before or between periods of use or operation;
much more kinds of stowage configurations can be designed and are made possible than with existing technology;
tension elements have small weight and stowage volume, and
are easily fabricated to precision;
the preloading system need not be precise—often, nor the exterior support of the whole;
“smaller” functional units are easier to fabricate, handle, move, replace;
lends itself to a modular engineering approach;
geometric adjustments can be effected in a simple way by means of conventional actuators, if necessary.

1. A structure, comprising
a first functional element (11) and a second functional element (12), said functional elements (11, 12) being form-retentive and being cooperatively functional in an operational state of the structure, in said operational state the functional elements (11, 12) having a predetermined relative spatial arrangement and being distanced from each other;
a tension assembly (20) coupling the functional elements (11, 12) to each other, the tension assembly (20) being adapted to be taut in said operational state and being coupled to the first functional element (11) by respective first couplings (41) and to the second functional element (12) by respective second couplings (42); the functional elements (11, 12), the couplings (41, 42) and the tension assembly (20) together forming a tensioned assembly; and
a tensioning assembly (30) coupled to the tensioned assembly, the tensioning assembly (30) being adapted to exert a repulsive force distancing the first functional element (11) and the second functional element (12) for maintaining said operational state,
wherein the system compliance of the tensioned assembly is less than 60% of the system compliance of the tensioning assembly (30), the system compliance of an assembly being defined as the absolute value of the work done by forces and/or moments exerted on said assembly in the operational state, on displacements with respect to the operational state that would be caused by a 1% increase of said forces and/or moments.

2. The structure according to claim 1, characterized in that the functional elements (11, 12) comprise functional components, wherein the ratio of a largest dimension to a smallest dimension of a smallest convex envelope enclosing the complete geometries of the entire set of functional components in the operational state is less than 10.

3. The structure according to claim 1, characterized by having a compact stowed state in which at least one element of the tensioning assembly (30) is in a preloaded state, and a deployed state corresponding to said operational state.

4. The structure according to claim 1, characterized in that the tension assembly comprises tension elements (21) selected from a group consisting of: cable-like elements, fabric-like elements, chain-like elements, net-like elements.

5. The structure according to claim 4, characterized by comprising collapsible interconnecting tension elements (21) having opposite ends, the opposite ends of a tension element (21) being attached to two respective elements of the structure thereby interconnecting the two respective elements with each other, the lengths of said tension elements (21) determining the shape of said operational state including the predetermined relative spatial arrangement of the functional elements (11, 12).

6. The structure according to claim 4, characterized in that in the tension assembly (20) at least six tension elements (21) are coupled to each of the functional elements (11, 12).

7. The structure according to claim 6, characterized in that the tension assembly comprises six tension elements (21), and three couplings (41; 42) for each of the first and second functional elements (11, 12), wherein each first coupling (41) is interconnected with two second couplings (42) by two respective tension elements (21).

8. The structure according to claim 4, characterized in that the tension assembly further comprises element(s) selected from a group consisting of: articulated deployable elements, spreader elements, plate-like elements, interconnecting elements.

9. The structure according to claim 1, characterized in that the tensioned assembly has peripheral elements being arranged oppositely in the tensioned assembly, wherein the tensioning assembly (30) has opposite ends being coupled to the peripheral elements, respectively.

10. The structure according to claim 9, characterized in that the tensioning assembly (30) comprises at least one spring-like element (31, 35, 36, 37) arranged to urge said first functional element (11) and said second functional element (12) to their predetermined relative spatial distanced arrangement.

11. The structure according to claim 9, characterized in that the tensioning assembly (30) comprises at least one spring-like member (35, 36, 37) formed in a spatially spiraling manner.

12. The structure according to claim 11, characterized in that the tensioning assembly (30) comprises multiple spring-like members (37) formed in a spatially spiraling manner.

13. The structure according to claim 1, characterized in that the tensioning assembly (30) comprises an elastic, a spring-loaded, a pneumatic, an inflatable or a hydraulic element.

14. The structure according to claim 4, characterized by comprising a functional element (11, 12) coupled indirectly, via further tension element(s) (21) to the tensioning assembly (30).

15. The structure according to claim 1, characterized in that the tensioning assembly (30) comprises radially arranged resilient elements (33).

16. The structure according to claim 15, characterized in that the resilient elements (33) are wrappable around a hub (34).

17. The structure according to claim 1, characterized in that the tensioning assembly (30) comprises a pressurized envelope (60, 61, 62) and the tensioned structure is located at least in part in the interior of the envelope (60, 61, 62).

18. The structure according to claim 17, characterized in that at least one functional element (12) is integrated into the wall of the envelope (61).

19. The structure according to claim 17, characterized in that the pressurized envelope (60, 61, 62) forms a part of a buoyant device or of a vehicle.

20. The structure according to claim 1, characterized in that the functional elements (11, 12) comprise functional components being cooperatively functional with respect to electromagnetic waves.

21. The structure according to claim 20, characterized in that the functional components are selected from a group consisting of: generating components, emitting components, directing components, reflecting components, focusing components, diffracting components, filtering components, transmitting components, shading components, blocking components, sensing components, measuring components, image or signal projecting components, and image or signal capturing components.

22. The structure according to claim 20, characterized in that at least one element of the tensioning assembly (30) or of the tension assembly (20) is transparent to the electromagnetic waves managed.

23. The structure according to claim 1, characterized by comprising a functional element having a folded deployable state, and a fixedly opened state for said operational state of the structure.

24. The structure according to claim 4, characterized by comprising an actuator device coupled either to a tension element (21), to a coupling (41, 42) of the tension element (21), to a functional element (11, 12) or to an internal non-tension element of the tension assembly, the actuator device being adapted to adjust the shape of, the relative distance, and/or relative orientation between the functional elements (11, 12).

25. The structure according to claim 1, characterized by having functional elements (11, 12) with a functional size fraction of at least 1/10, the functional size fraction of a functional element being defined as the ratio
of the diameter of the smallest sphere that fully encloses all functional components of the functional element,
to that of the smallest sphere that encloses the entire functional element.

26. The structure according to claim 1, characterized by having functional elements (11, 12) with a functional component gap fraction less or equal 9/10, the functional component gap fraction of a functional element being defined as the ratio
of the largest gap between groups minimal spheres, each sphere enclosing a functional component of the functional element,
to a diameter of a smallest sphere enclosing the entire functional element.
